(19) United States
(12) Patent Application Publication
(10) Pub. No.: US 2024/0375119 A1
(43) Pub. Date: Nov. 14, 2024

(54) GRINDING UNIT

(71) Applicant: TREFFLER MASCHINENBAU GMBH & CO. KG, Pottmes-Echsheim (DE)

(72) Inventor: Paul Christian TREFFLER, Echsheim (DE)

(21) Appl. No.: 18/553,181

(22) PCT Filed: May 27, 2022
(86) PCT No.: PCT/EP2022/064422

§ 371 Date: Sep. 28, 2023

(30) Foreign Application Priority Data
Mar. 31, 2021 (DE) 202021101727.9

(51) Int. Cl. B02C 18/18; B02C 9/02; B02C 18/14

(52) U.S. Cl. CPC B02C 18/182; B02C 9/02; B02C 18/14

(57) ABSTRACT

Disclosed is a mill comprising a grinding unit, wherein a rotatable blade element (9) drivable by a motor (2) is arranged in the grinding unit. The blade element (9) has a hub portion and an outer ring portion concentric with an axis of rotation of the blade element (9), which are connected by at least one curved web, the blade element (9) having at least one through-passage at its outer circumference in connection with a space between the hub portion and the outer ring portion.

The invention relates to a mill for the grinding of grinding stock. Various types of mills are known for grinding, for example, grain for the production of flour. In addition to traditional stone mills, also mills are used in which the grinding work is performed by means of a blade set that rotates in a grinding unit and comminutes the grinding stock directly or by means of impact on an impact plate. Such a mill is described in the German utility model DE 20 2004 005 117.

From the U.S. Pat. No. 4,374,573 a mill-like machine for comminuting scrap material is known, in which the grinding stock is supplied via an inlet and discharged in the ground state via an outlet. The grinding process is carried out by disc-like blades, which are joined together to form blade sets and are driven by a motor. These disc-like blades partly have cutting plates on their outer circumference and are mounted on a blade shaft at a constant distance by means of equally thick spacer discs.

The object of the invention is to further increase the efficiency of such a mill.

This object is achieved by a mill comprising the features of claim 1 or claim 3.

According to the invention, a mill is provided which comprises a grinding unit in which a rotatable blade element drivable by a motor is arranged and having a hub portion and an outer ring portion which is concentric with an axis of rotation of the blade element, which are connected by at least one curved web, and in that the blade element has on its outer circumference at least one through-passage which is in connection with a space between the hub portion and the outer ring portion.

This blade element can be formed integrally for a cost-effective production.

Alternatively, according to the invention, a mill is provided which comprises a grinding unit in which a rotatable blade element including multiple disc-shaped blades, which are spaced apart by means of at least one spacer element and which are drivable by a motor, wherein at least one blade has a hub and an outer ring concentric with an axis of rotation of the blade element, which are connected by at least one curved web.

Due to the aforementioned design of the blade element with the curved web, when the blade element rotates, a fluid flowing through the grinding unit is accelerated by an effect similar to that of a radial fan, which results in a higher flow velocity and an increased volume flow of the fluid and thus also of the grinding stock conveyed with the fluid. Thus, a very high grinding performance and an increase in the efficiency of the mill can be achieved. The high flow velocity of the fluid and the grinding stock also ensures that the grinding stock can be ground more finely. Furthermore, the higher fluid flow effectively prevents deposits in the grinding unit and inside the mill. This is advantageous due to improved hygiene and reduced maintenance.

Although it is possible to provide only one web on the blade element, it is preferred to provide webs in an opposing or star-shaped manner to avoid imbalance and to further increase the flow velocity and volume flow of the fluid.

Further, it is advantageous to form the web or webs curved backward in a direction of rotation of the blade element. Thus, a leading edge of the web or webs in the direction of rotation is convex or curved outward, and a trailing edge of the web or webs in the direction of rotation is concave or curved inward. As in a radial fan with backward-curved blades, this allows a large fluid flow and a high pressure build-up to be achieved. In such a design of the webs, it is advantageous in terms of optimized fluid guidance and fluid acceleration if a radius of curvature of at least part of the trailing edge of the web or webs in the direction of rotation is 65 mm.

In applications with low rotational speeds of the grinding unit, on the other hand, it can be advantageous to form the web or webs curved forward in a direction of rotation of the blade element. Thus, a leading edge of the web or webs in the direction of rotation is concave or curved inward, and a trailing edge of the web or webs in the direction of rotation is convex or curved outward. This can ensure a large volume flow and a high flow velocity of the fluid, even in such applications.

Depending on the intended use of the mill, it can also be advantageous for optimizing the fluid guidance if the trailing edge in the direction of rotation and/or a leading edge in the direction of rotation of the web or webs has/have different radii of curvature at different locations in a radial direction of the blade element.

Further, it is advantageous to decrease a width in a circumferential direction of the web or webs outward in the radial direction. On the one hand, such a design can optimize the fluid guidance in the grinding unit, and on the other hand, this achieves a reduced load on the bearings of the blade element due to a reduced mass moment of inertia of the blade element.

Furthermore, the spacer element or spacer elements is/are preferably drivable by the motor together with the blades, wherein the blades and the spacer elements are rotatable about the same axis of rotation and at least one spacer element has a contour that deviates from a round cross-section and comprises at least one projection that is curved in the same direction as the web or webs with respect to the direction of rotation.

Such a design of the blade element can further increase the flow velocity and the volume flow of the fluid and optimize the fluid guidance. In addition, with this design, spaces between the blades are filled by the spacer elements. This effectively prevents deposits of the grinding stock. To avoid imbalance, the number and arrangement of the projection or projections preferably correspond to the number and arrangement of the web or webs. To achieve an advantageous fluid guidance, the contour of the projection or projections preferably corresponds at least partially to the contour of the web or webs.

Further, it is advantageous to form the projection or projections such that the projection or projections extend/extends to the outer circumference of the outer ring. This further reduces the volume of the spaces between blades. Deposits of grinding stock between the blades can thus be effectively prevented.

Furthermore, the projection or projections is/are preferably formed such that a width in a circumferential direction of the projection or projections decreases outward in the radial direction. This allows for a further optimized fluid flow and a reduced load on the bearings of the blade element due to a reduced mass moment of inertia of the blade element.

To further optimize the fluid guidance in the above-described grinding unit for different purposes, the blades provided with the webs and the spacer elements provided with the projections can be arranged in different ways as follows to obtain an optimized geometry of the fluid guidance surfaces.

The blades and the spacer element or spacer elements can be provided such that the trailing edge of the web or webs in the direction of rotation and a trailing edge of the projection or projections in the direction of rotation are aligned.

Alternatively, the blades and the spacer element or spacer elements adjacent to each other can each be provided such that the trailing edge of the web or webs in the direction of rotation and a trailing edge of the projection or projections in the direction of rotation are offset from each other by a certain amount.

In addition, the blades and the spacer element or spacer elements can be provided such that the leading edge of the web or webs in the direction of rotation and a leading edge of the projection or projections in the direction of rotation are aligned.

Alternatively, the blades and the spacer element or spacer elements adjacent to each other can each be provided such that the leading edge of the web or webs in the direction of rotation and a leading edge of the projection or projections in the direction of rotation are offset from each other by a certain amount:

In an advantageous design of the blade element, each blade of the blade element has the same number of webs which are arranged in a star shape with equal distances between the webs, and each spacer element of the blade element has a number of projections corresponding to the number of webs of the blades, the projections being arranged in a star shape with equal distances between the projections and the contour of which corresponds at least partially to the contour of the webs. Here, furthermore, the blades and the spacer elements are provided such that the leading edges of the webs and the leading edges of the projections as well as the trailing edges of the webs and the trailing edges of the projections are aligned.

This design of the blade element achieves a very good (high) flow velocity and a very good (high) volume flow of the fluid flowing through the grinding unit. This results in a very high fineness of the grinding stock. Furthermore, this is particularly effective in preventing deposits of the grinding stock in the grinding unit, thus achieving a high standard of hygiene. In addition, the design of the grinding stock described above prevents grinding stock, such as chickpeas or corn, from accumulating between the blades. This effectively prevents an imbalance of the blade element.

Furthermore, to optimize the grinding performance of the above-described mill, teeth having cutting plates, which are significantly involved in the grinding process, can be provided on the outer circumference of the blade element in various ways.

Accordingly, a plurality of teeth having cutting plates on the front flanks in the direction of rotation can be arranged on the outer circumference of the outer ring portion or outer rings, the teeth being inclined forward in the direction of rotation with respect to a radius of the blade element.

Alternatively, a plurality of teeth having cutting plates on the front flanks in the direction of rotation can be arranged on the outer circumference of the outer ring portion or outer rings, the teeth being inclined backward in the direction of rotation with respect to a radius of the blade element.

To further optimize the grinding performance of the mill, the spacer element or spacer elements is/are preferably designed as spacer disc or spacer discs and the thickness of the spacer disc or spacer discs in an axial direction of the blade element is preferably in a range of including 4 mm to including 5 mm.

The spacer discs can have projections on their outer circumference that contribute to a further swirling of the fluid flowing through the grinding unit. These projections can have various contours, including rectangular shapes as well as triangular or wing-like shapes. Depending on the design of these projections and the number of corresponding spacer discs used, the flow can be influenced advantageously. The spacer discs can have a continuous surface or be ring-shaped. In the case of a continuous design, openings in the form of holes or the like can again be provided in the surface to allow a flow through.

End discs can be similarly provided at the lateral end of the blade set. Like the discussed spacer discs, these end discs can have projections in the outer circumference. However, since they form the lateral end discs, projections can also be provided on the surface, i.e. in the axial direction of the blade set. It is possible to use end discs that only have projections in the axial direction, as well as discs that have projections in the axial and radial directions, as described above. Both sides, or only one side, of the blade set can be provided with corresponding end discs. These end discs also have an advantageous effect on the flow in the grinding unit. As with the spacer discs discussed, the projections can have various shapes. The discs themselves can be designed as a continuous disc or ring-shaped disc. In a continuous design, openings in the form of bores or other designs can be provided to allow a flow through.

The invention is described in more detail based on preferred embodiments.

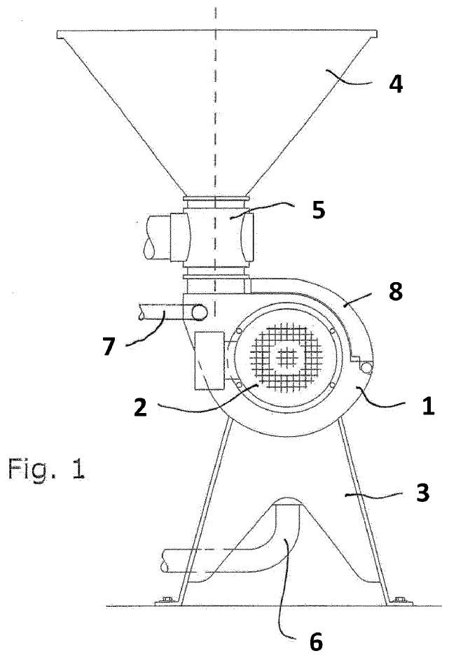

FIG. 1 shows a mill according to the invention in a first view.

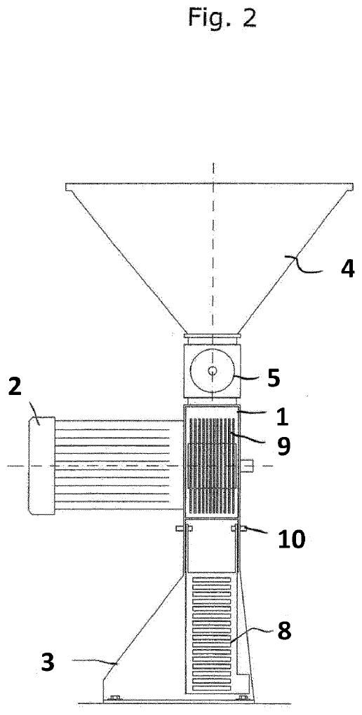

FIG. 2 shows the mill according to the invention in a second view at a 90° angle to the first view.

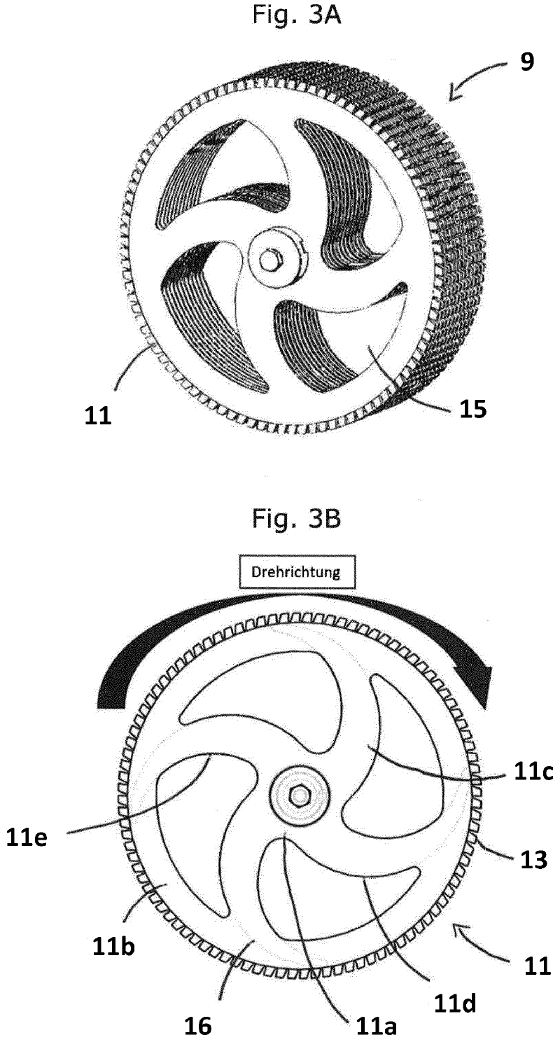

FIG. 3A shows a perspective view of a blade set of the mill according to the invention shown in FIG. 1 and FIG. 2.

FIG. 3B shows the blade set of the mill according to the invention shown in FIG. 3A, viewed in an axial direction of the blade set.

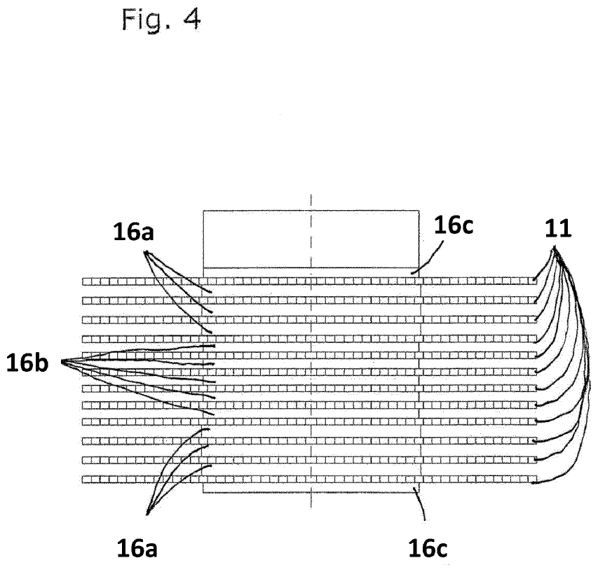

FIG. 4 shows the blade set of the mill according to the invention shown in FIG. 3A and FIG. 3B, viewed in a direction perpendicular to the axial direction of the blade set.

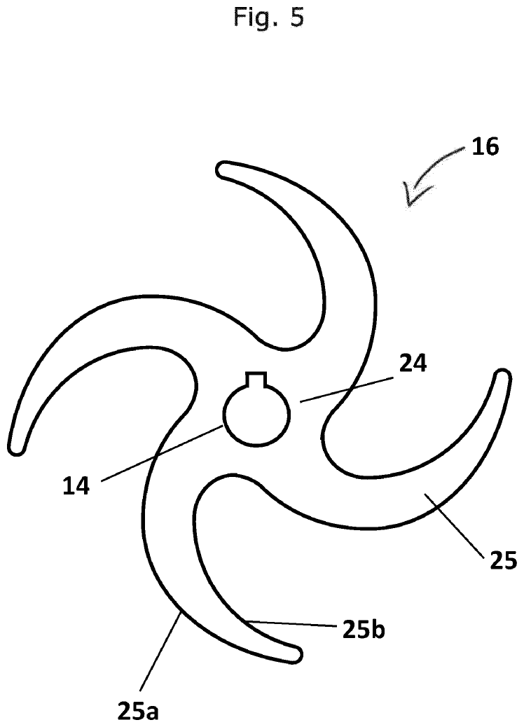

FIG. 5 shows a spacer disc of the blade set according to the invention shown in FIG. 3A, FIG. 3B and FIG. 4.

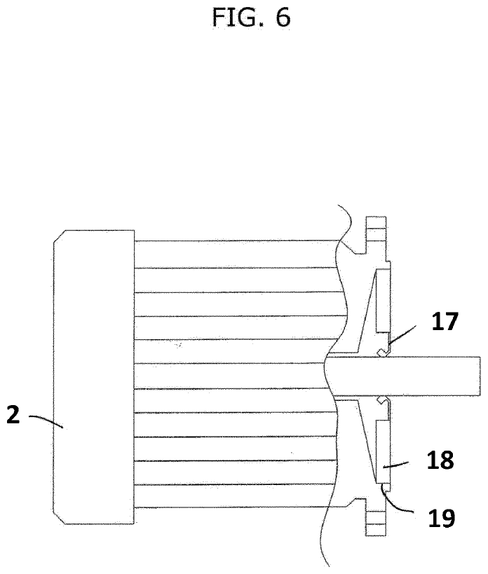

FIG. 6 shows a sketch of a drive motor with an additional shaft seal of the mill according to the invention.

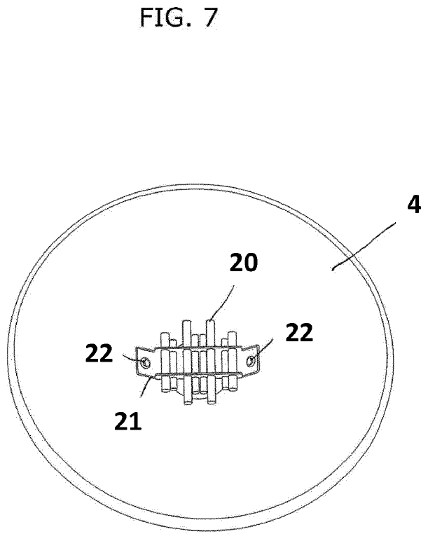

FIG. 7 shows a grinding stock funnel of the mill according to the invention.

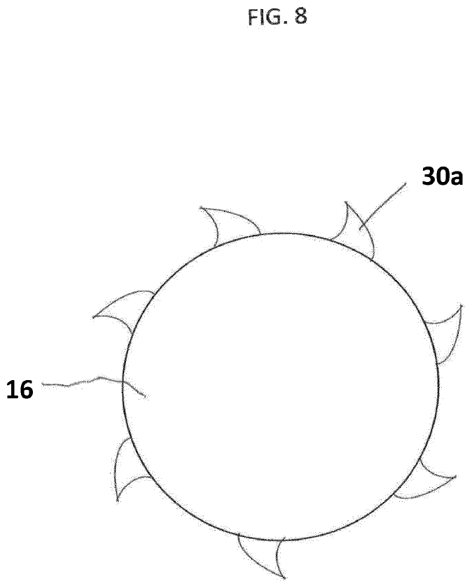

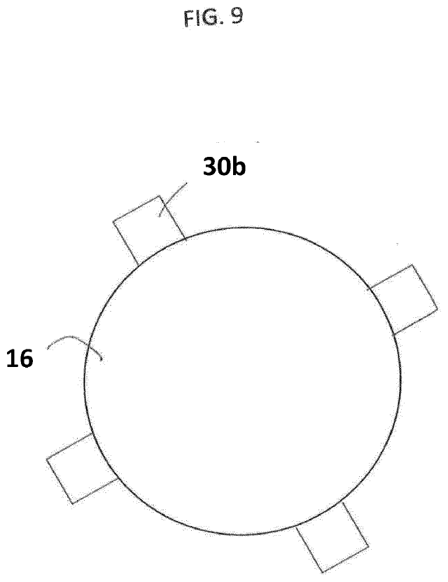

FIGS. 8 and 9 show spacer discs with projections on the outer circumference to influence the flow.

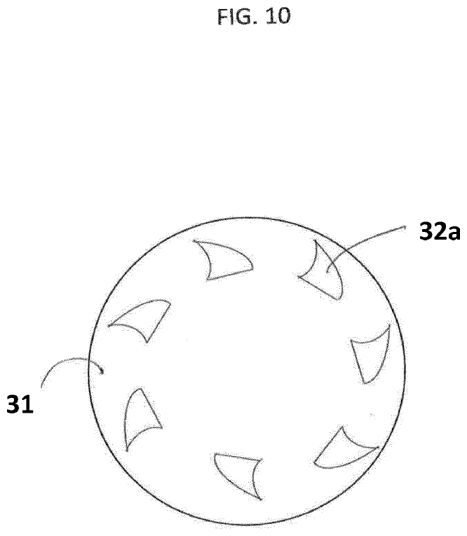

FIGS. 10 to 13 show end discs with projections in the axial direction of the blade set to influence the flow.

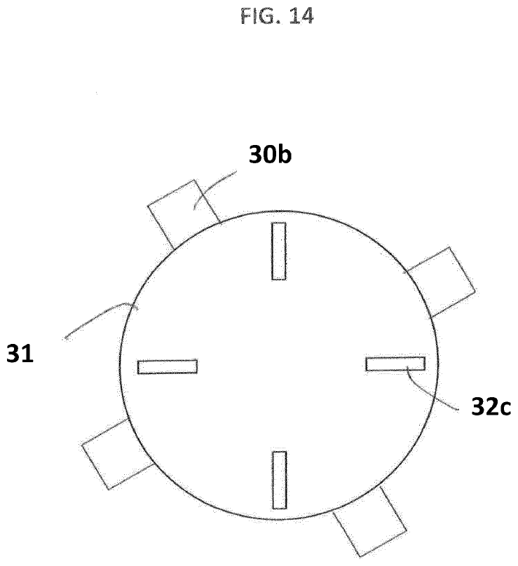

FIG. 14 shows an end disc with radial and axial projections to influence the flow.

FIG. 1 shows a grinding unit housing 1 of the mill according to the invention to which the drive motor 2 is flange-mounted. The grinding unit housing 1 with flange-mounted drive motor 2 is supported by a stand 3. At the upper side of the grinding unit housing 1, a regulated grinding stock inlet 5 is arranged, which is supplied with grinding stock by a grinding stock funnel 4. The grinding stock is usually blown in via a conveying fluid flow. In the regulated grinding stock inlet 5 there is a regulator, not shown, by means of which the grinding stock flow supplied from the grinding stock funnel 4 can be regulated. Below the grinding stock inlet 5, a fluid inlet 7 is provided laterally on the grinding unit housing 1, through which a fluid can additionally be blown into the grinding unit housing 1.

During operation of the mill, the grinding stock is conveyed in the grinding unit with the fluid, which flows together with the grinding stock into the grinding unit via the grinding stock funnel 4 and optionally through the fluid inlet 7, and is swirled by the rotating blade set 9, which is a blade element of the embodiment, arranged in the grinding unit. This allows the grinding stock to be finely ground by the blade set 9.

As grinding stock, the mill can process, for example, grain such as corn, wheat or barley, legumes such as peas or lentils, or mustard or beetroot. Depending on the respective grinding stock to be processed, air, water or oil, for example, can be used as fluid.

A grinding stock outlet 6 is located on the underside of the grinding unit housing 1 at the lowest point of the interior of the grinding unit and leads through a pipe to a collection container, not shown, in which the ground grinding stock is collected. Usually, the grinding stock is extracted from the grinding unit housing 1 by means of negative pressure so that residues and the like do not remain in the grinding unit housing 1. When the mill is operated with water or oil as the conveying fluid, the extraction of the grinding stock from the grinding unit housing 1 by means of negative pressure can be dispensed with.

In the illustration according to FIG. 2, the mill is shown with the grinding unit open. For this purpose, the wall of the grinding unit housing 1 shown is opened by means of a flap 8 so that the blade set 9 is visible. The flap 8 is pivotably mounted on a bolt 10 and locked to the grinding unit housing 1 by a locking mechanism not explained in more detail. A shaft of the drive motor 2, which is not visible in FIG. 2, projects into the interior of the grinding unit and is directly connected there with the blades 11 of the blade set 9.

FIG. 3A, FIG. 3B and FIG. 4 show the blade set 9 of the mill according to the invention. The blades 11 of the blade set 9 have a disc-like shape with four large openings, as can be seen clearly in FIG. 3A. FIG. 3B shows a plan view of the blade set 9. Thus, in FIG. 3B, the contour of one of the outer blades 11 of the blade set 9 is clearly visible. Furthermore, FIG. 3B shows the direction of rotation of the shaft of the drive motor 2.

As shown in FIG. 3B, the blade 11 has a central base part that forms a hub 11a. The hub 11a is provided with openings, not shown, which serve to mount the blade on the shaft of the drive motor 2 in a rotationally fixed manner. Furthermore, the blade 11 has an outer ring 11b concentric with the shaft of the drive motor 2. The hub 11a and the outer ring 11b are connected by four webs 11c, which are arranged in a star shape with equal distances between the webs 11c. The webs 11c are curved backward in the direction of rotation. In other words, a leading edge 11d of the webs 11c in the direction of rotation is convex or curved outward, and a trailing edge 11e of the webs 11c in the direction of rotation is concave or curved inward. Furthermore, the webs 11c taper towards the outside. In the specific embodiment, the radius of the circumferentially trailing edge 11e of the webs 11c is 65 mm.

On the outer circumference of the outer ring 11b, the blade 11 is provided with teeth 13. The front flanks of the teeth 13 in the direction of rotation are provided with cutting plates. The teeth 13 and also the cutting plates are slightly inclined forward in the direction of rotation with respect to the radius of the blade 11. The disc-like base body of the blade 11 has a thickness of 2 mm. The cutting plates are made of a grindable or regrindable steel, so that a high sharpness of the blade 11 can be ensured.

In the specific embodiment, the blades 11 are mounted as a blade set 9 consisting of twelve blades 11 in the interior of the grinding unit. The disc-like blades 11 are mounted on the shaft of the drive motor 2 at a predetermined distance. Spacer discs 16 are used for this purpose, which ensure the desired distance between the blades 11, as is evident from FIG. 4. The spacer discs 16 are spacer elements of the embodiment. In FIG. 4, the blades 11 are shown in simplified form as discs. Since twelve blades 11 are used, eleven spacer discs 16 must be used. In the specific embodiment, three outer spacer discs 16a of the blade set 9 each have a thickness of 5 mm, while the five spacer discs 16b used in the central area of the blade set 9 have a thickness of 4 mm. Furthermore, a 4 mm thick end disc 16c is also mounted to the end, i.e. to the right or left of the outermost blade 11. Such an arrangement and variation of the blade distances has proved successful and led to very good grinding results.

In FIG. 3B, dashed lines indicate the contour of a spacer disc 16. As shown in FIG. 3B, the contour of the spacer disc 16 corresponds to the contour of the blade 11 in the area of the hub 11a and the webs 11c. Furthermore, the spacer disc 16 extends to the outer circumference of the outer ring 11b.

FIG. 5 shows the contour of the spacer disc 16 in a plan view. As shown in FIG. 5, like the blade 11, the spacer disc 16 has a central base part 24 provided with openings 14 that allow the spacer disc 16 to be mounted on the shaft of the drive motor 2 in a rotationally fixed manner. Further, the spacer disc 16 has four projections 25 extending radially outward from the base part 24 and arranged in a star shape with equal distances between the projections 25. As described above and shown in FIG. 3B, the projections 25 extend to the outer circumference of the outer ring 11b of the blade 11 and taper towards the outside. A small radius is formed at the outer end of the projections. Further, the projections 25 continuously merge into the base part 24 with further radii.

Furthermore, the projections 25 are curved backward corresponding to the webs 11c of the blades 11 in the direction of rotation of the blade set 9. Thus, a leading edge 25a of the projections 25 in the direction of rotation is convex or curved outward, and a trailing edge 25b of the projections 25 in the direction of rotation is concave or curved inward. In the specific embodiment, as in the case of the webs 11c of the blades 11, the radius of the trailing edge 25b of the projections 25 in the direction of rotation of the spacer disc 16 is 65 mm.

Due to the above-described corresponding contours of the blades 11 provided with the webs 11c and the spacer discs 16 provided with the projections 25, the blades 11 and the spacer discs 16 can be assembled to form the blade set 9 shown in FIG. 3A. In the blade set 9 shown in FIG. 3A, the blades 11 and the spacer discs 16 are arranged so that the leading and trailing edges of the webs 11c in the direction of rotation and the projections 25 are aligned. This arrangement results in four openings 15, which are bounded by fluid guidance surfaces formed by the aligned edges of the webs 11 and the projections 25. The fluid guidance surfaces are curved backward in the direction of rotation in accordance with the curvature of the webs 11c and the projections 25.

Furthermore, as described above, the contour of the spacer discs 16 corresponds to the contour of the blades 9 in the area of the hub 11a and the webs 11c. However, the spacer discs 16 do not have an outer ring. Thus, in the blade set 9, through-passages are formed between the blades 11 in the area of the outer rings 11b of the blades 11 through which the fluid can pass.

Due to the above-described design of the blade set 9 with the openings 15, the curved fluid guidance surfaces and the through-passages formed between the outer rings 11b of the blades 11, the rotation of the blade set 9 achieves an effect similar to that of a radial fan. Thus, when the blade set 9 rotates, the fluid enters axially through the openings 15 and exits radially through the through-passages formed between the outer rings 11b of the blades 11. Thereby, the fluid is accelerated by the fluid guidance surfaces of the blade set 9.

FIG. 6 shows the drive motor 2 with an additional shaft seal 17. The additional shaft seal 17 is mounted by means of an additional flange 18, which is arranged on a collar 19 of the housing of the drive motor 2. In the specific embodiment, the additional flange 18 is screwed to the collar 19.

FIG. 7 shows the grinding stock funnel 4, in the inner area of which rod-shaped magnets 20 are mounted at the transition Into the grinding stock inlet 5, which are mounted in the interior of the grinding stock funnel 4 by means of a support 21 and screws 22. Metallic objects that could cause damage to the blades 11 are kept away from the grinding unit with said magnets 20. To remove the metallic objects picked up by the magnets 20, the support 21 including all magnets 20 can be completely removed after loosening the screws 22. Thus, metallic objects can be easily picked up by the magnets 20.

The embodiment described above may be modified as follows.

The blade set of the mill described above can alternatively be designed with webs, projections and fluid guidance surfaces that are curved forward in the direction of rotation, which is particularly advantageous in applications with low rotational speeds of the grinding unit.

Alternatively, the blades and the spacer discs can be arranged in the blade set of the mill described above in such a way that the leading edges and/or the trailing edges of the webs and projections are not aligned, but are each offset from each another by a certain amount. As a result, fluid guidance surfaces inclined in the axial direction can be formed on the blade set, resulting in advantageous fluid guidance depending on the intended use.

In a second embodiment, the mill described above can have, instead of the blade set of the first embodiment, a blade element which has a shape corresponding to the shape of the blade set described above, but which is not formed of a plurality of blades spaced apart by spacer discs. Such a blade element has a cylindrical hub portion which corresponds to the mutually arranged base parts of the blades and the spacer discs of the blade set described above and which is provided with openings that serve to mount the blade element on the shaft of the drive motor in a rotationally fixed manner. Further, the blade element of the second embodiment has a cylindrical outer ring portion corresponding to the mutually arranged outer rings of the blades of the blade set described above. The hub portion and the outer ring portion of the blade element of the second embodiment are connected to each other by at least one curved web corresponding to the mutually arranged webs and projections of the blades and the spacer discs of the blade set described above.

Thus, openings defined by fluid guidance surfaces are also formed in the blade element of the second embodiment, the fluid guidance surfaces here being surfaces of the hub portion, the outer ring portion and the webs. Furthermore, in the blade element of the second embodiment, through-passages are formed in the radial direction in the outer ring portion, which are in connection with the openings. These through-passages correspond to the through-passages between the outer rings of the blades of the blade set described above.

Due to the above-described design of the blade element of the second embodiment with the openings, the curved fluid guidance surfaces and the through-passages formed in the outer ring portion, the rotation of the blade element also achieves an effect with the blade element of the second embodiment that is comparable to the effect of a radial fan. Thus, when the blade element of the second embodiment rotates, the fluid enters axially through the openings and exits radially through the through-passages formed in the outer ring portion. Thereby, the fluid is accelerated by the fluid guidance surfaces of the blade element of the second embodiment.

The blade element of the second embodiment can have arbitrarily designed webs. These can be curved forward or curved backward, for example, and have various radii of curvature. Furthermore, the fluid guidance surfaces of the blade element formed by the webs can be inclined in the axial direction with respect to the axis of rotation of the blade element. The through-passages of the blade element can also have any shape as long as they are in connection with the openings bounded by the fluid guidance surfaces.

For example, the blade element of the second embodiment described above can be integrally formed from a cylindrical raw material by forming the webs, openings, fluid guidance surfaces, and through-passages described above by machine processing. Alternatively, multiple correspondingly shaped components can be joined together to form such a blade element.

The above-described blade element of the second embodiment can also be manufactured using primary shaping manufacturing methods (e.g., casting), forming manufacturing methods, or additive manufacturing technologies (e.g., selective laser sintering). The skilled person suitably selects the respective manufacturing method on the basis of the desired shape of the blade element.

FIGS. 8 and 9 show spacer discs 16 with projections 30 on the outer circumference. The spacer discs are formed with a continuous surface and have protruding projections on the outer circumference, i.e. in the radial direction. In the embodiment according to FIG. 8, these projections 30a are fin-like or tooth-like. In the embodiment according to FIG. 9, the projections 30b are rectangular, nearly square. When the spacer discs rotate, the projections 30 cause the surrounding fluid to swirl and thus influence the flow in the grinding unit. Depending on the grinding stock, this can significantly improve the grinding result. In the embodiment according to FIG. 8 with an asymmetrical design of the projections, the spacer disc 16 can also be inserted in reverse. Therefore, it is possible that the fin-like projections 30 shown advance with the tip when the spacer disc 16 rotates, i.e., the tip rotates in the direction of rotation, or that the flat flank of the projection 30a extending from the circumference advances when the spacer disc is inserted in reverse.

FIG. 10 shows an end disc 31 that can be mounted on the left or right outer side of the blade set. In embodiment 10, the end disc 31 has projections 32a on its surface in the outer area, which extend substantially in the axial direction of the blade set. In the embodiment according to FIG. 10, these are shovel-shaped. End discs 31 can be mounted on both sides of the blade set or only on one side. The direction of rotation of the outwardly protruding projections 32a depends on whether the end disc 31 is mounted on the right side or left side of the blade set, so that different effects on the fluid flow are possible.

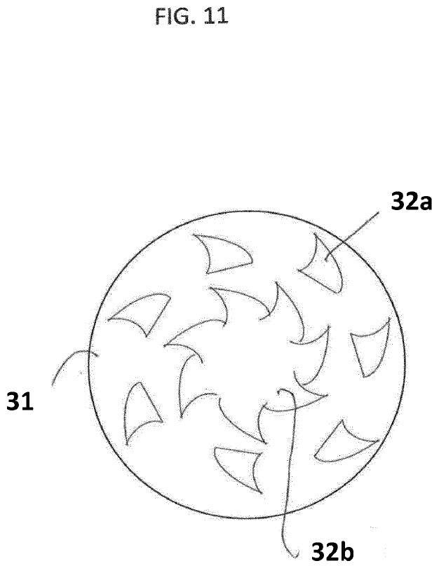

FIG. 11 describes an embodiment substantially corresponding to that of FIG. 10, with a further projection 32b provided in the central area of the end disc 31.

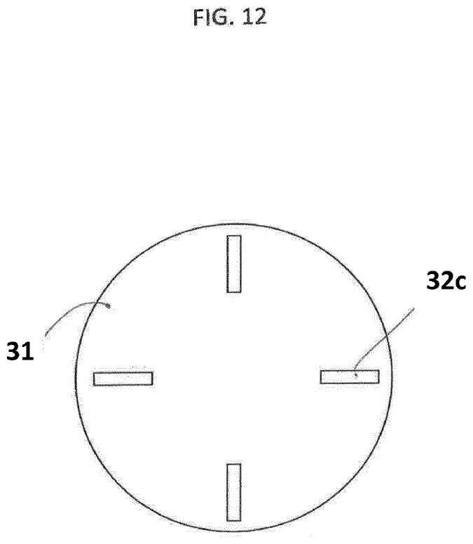

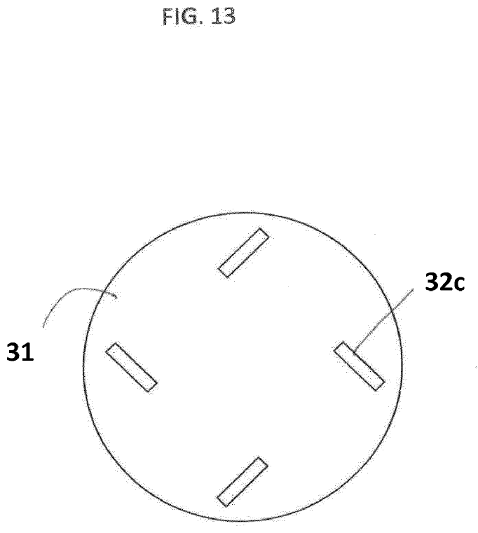

FIGS. 12 and 13 show end discs 31 provided with projections 32c, which are rectangular plates. The orientation of these projections 32c can be radial, as shown in FIG. 12, but they can also be arranged inclined to the radial direction, as shown in FIG. 13. Depending on the position of the projections 32c, a different swirling of the fluid results.

FIG. 14 shows an end disc 31, the projections of which are a combination of the projections 30b already shown in FIG. 9 with the projections 32c shown in FIG. 12. However, swirling of the fluid is achieved both at the circumference of the disc and at the sides of the disc.

1. A mill comprising a grinding unit, wherein a rotatable blade element (9) drivable by a motor (2) is arranged in the grinding unit, characterized in that the blade element (9) has a hub portion (11a) and an outer ring portion (11b) which is concentric with an axis of rotation of the blade element (9), which are connected by at least one curved web (11c), and in that the blade element (9) has on its outer circumference at least one through-passage which is in connection with a space between the hub portion (11a) and the outer ring portion (11b).

2. The mill according to claim 1, wherein the blade element (9) is formed integrally.

3. A mill comprising a grinding unit, wherein a rotatable blade element (9) including multiple disc-shaped blades (11), which are spaced apart by means of at least one spacer element (16) and which are drivable by a motor (2), is arranged in the grinding unit, characterized in that at least one blade (11) has a hub (11a) and an outer ring (11b) concentric with an axis of rotation of the blade element (9), which are connected by at least one curved web (11c).

4. The mill according to claim 3, characterized in that the spacer element or spacer elements (16) together with the blades (11) are drivable by the motor (2), the blades (11) and the spacer elements (16) are rotatable about the same axis of rotation, and at least one spacer element (16) has a contour that deviates from a round cross-section and comprises at least one projection (25) that is curved in the same direction with respect to the direction of rotation as the web or webs (11c).

5. The mill according to claim 4, characterized in that the number and arrangement of the projection or projections (25) corresponds to the number and arrangement of the web or webs (11c).

6. The mill according to claim 4 or 5, characterized in that the contour of the projection or projections (25) corresponds at least partially to the contour of the web or webs (11c).

7. The mill according to any one of claims 4 to 6, characterized in that the projection or projections (25) extend/extends to the outer circumference of the outer ring (11b).

8. The mill according to any one of claims 4 to 7, characterized in that a width in a circumferential direction of the projection or projections (25) decreases outward in the radial direction.

9. The mill according to any one of claims 4 to 8, characterized in that the blades (11) and the spacer element or spacer elements (16) are provided such that the trailing edge (11e) of the web or webs (11c) in the direction of rotation and a trailing edge (25b) of the projection or projections (25) in the direction of rotation are aligned.

10. The mill according to any one of claims 4 to 8, characterized in that the blades (11) and the spacer element or spacer elements (16) adjacent to each other are each provided such that the trailing edge (11e) of the web or webs (11c) in the direction of rotation and a trailing edge (25b) of the projection or projections (25) in the direction of rotation are offset from each other by a certain amount.

11. The mill according to any one of claims 4 to 10, characterized in that the blades (11) and the spacer element or spacer elements (16) are provided such that the leading edge (11d) of the web or webs (11c) in the direction of rotation and a leading edge (25a) of the projection or projections (25) in the direction of rotation are aligned.

12. The mill according to any one of claims 4 to 10, characterized in that the blades (11) and the spacer element or spacer elements (16), which are adjacent to each other, are each provided such that the leading edge (11d) of the web or webs (11c) in the direction of rotation and a leading edge (25a) of the projection or projections (25) in the direction of rotation are offset from each other by a certain amount.

13. The mill according to any one of claims 4 to 8, characterized in that each blade (11) of the blade element has the same number of webs (11c) arranged in a star shape with equal distances between the webs (11c), each spacer element (16) of the blade element has a number of projections (25) corresponding to the number of webs (11c) of the blades (11), the projections (25) being arranged in a star shape with equal distances between the projections (25) and the contour of which corresponds at least partially to the contour of the webs (11c), and wherein the blades (11) and the spacer elements (16) are provided such that the leading edges (11d) of the webs (11c) and the leading edges (25a) of the projections (25) as well as the trailing edges (11e) of the webs (11) and the trailing edges (25b) of the projections (25) are aligned.

14. The mill according to any one of claims 1 to 13, characterized in that at least two opposing webs (11c) are provided.

15. The mill according to any one of claims 1 to 14, characterized in that the number of webs (11c) is even.

16. The mill according to any one of claims 1 to 14, characterized in that the number of webs (11c) is odd.

17. The mill according to any one of claims 14 to 16, characterized in that the webs (11c) are arranged in a star shape with equal distances between the webs (11c).

18. The mill according to any one of claims 1 to 17, characterized in that the web or webs (11c) is/are curved backward in a direction of rotation of the blade element (9).

19. The mill according to claim 18, wherein a radius of curvature of at least a part of a trailing edge (11e) of the web or webs (11c) in the direction of rotation is 65 mm.

20. The mill according to any one of claims 1 to 17, characterized in that the web or webs (11c) is/are curved forward in a direction of rotation of the blade element (9).

21. The mill according to any one of claims 1 to 20, wherein the trailing edge (11e) in the direction of rotation and/or a leading edge (11d) in the direction of rotation of the web or webs (11c) has/have different radii of curvature at different locations in a radial direction of the blade element.

22. The mill according to any one of claims 1 to 21, wherein a width in a circumferential direction of the web or webs (11c) decreases outward in the radial direction.

23. The mill according to any one of claims 1 to 22, characterized in that a plurality of teeth (13), which have cutting plates on the front flanks in the direction of rotation, are arranged on the outer circumference of the outer ring portion or outer rings (11b), and the teeth (13) are inclined forward in the direction of rotation with respect to a radius of the blade element (9).

24. The mill according to any one of claims 1 to 22, characterized in that a plurality of teeth (13), which have cutting plates on the front flanks in the direction of rotation, are arranged on the outer circumference of the outer ring portion or outer rings (11b), and the teeth (13) are inclined rearward in the direction of rotation with respect to a radius of the blade element (9).

25. The mill according to any one of claims 3 to 24, wherein the spacer element or spacer elements is/are a spacer disc or spacer discs.

26. The mill according to claim 25, wherein the thickness of the spacer disc or spacer discs (16) in an axial direction of the blade element is in a range of including 4 mm to including 5 mm.

27. The mill according to claim 25 or 26, wherein the spacer disc (16) or spacer discs (16) has/have projections (30) on the outer circumference.

28. The mill according to claim 27, wherein the spacer disc (16) or spacer discs (16) is/are provided on their circumference with differently shaped projections (30).

29. The mill according to any one of claims 25 to 28, wherein the spacer disc (16) or spacer discs (16) is/are formed in a continuous manner with or without apertures or in a ring-like manner.

30. The mill according to any one of claims 1 to 29, wherein, in an axial direction of the blade element, the blade element is provided with an end disc (31) on the side, which is provided with projections (30, 32) on the circumference and on the free surface facing into the grinding chamber.

31. The mill according to claim 30, wherein end discs (31) are provided with multiple differently shaped projections (30, 32) and/or openings in the surface.
